(19) United States
(12) Patent Application Publication
(10) Pub. No.: US 2006/0058191 A1
(43) Pub. Date: Mar. 16, 2006

(54) Pesticide solvent system for reducing phytotoxicity

(75) Inventors: Mickey Brigance, Germantown, TN (US); Greg McManic, Germantown, TN (US); Tim Anderson, Hamilton, OH (US); Mike Pompeo, Mason, OH (US); Wally Thorne, Bedford, TX (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(73) Assignees: ADJUVANTS UNLIMITED ,INC.; COGNIS CORPORATION

(21) Appl. No.: 10/941,765

(22) Filed: Sep. 15, 2004

(51) Int. Cl. A01N 25/04; A01N 25/16

(52) U.S. Cl. 504/116.1; 504/365

(57) ABSTRACT

A pesticide composition for applying to soil or plants containing of at least one pesticidally active ingredient, at least one member selected from the group consisting of alkoxylates of C₆-C₁₈ alcohol, and mixtures thereof wherein the alkoxylates is with a polyoxyalkylene ranging from POE (1) through POE (20) and/or mixtures of different carbon chain lengths of C₆-C₁₈ with POE (1) to up to about POE (20) and POP (1) to POP (10), a counter balanced crop safe solvent, diluent, and an emulsifier.

### INTRODUCTION AND BACKGROUND

The present invention relates to pesticide compositions which exhibit enhanced performance properties such as solvency of a technical pesticide, increased plant safety of the solvent system, improved environmental properties, and broadened systemic potentiation of pesticides while maintaining typical performance characteristics. The compositions of the present invention may be in the form of a water emulsion, dispersion or reverse phase emulsion, emulsifiable concentrate (EC) formulations, microemulsifiable concentrates (MEC) and the like.

It is well known in agriculture to apply various agrochemicals to growing areas and soils by spraying. The growing areas may be crop areas in the field, which can be very large, or smaller growing areas such as those in greenhouses. Soil can be treated prior to seeding with the intended crop. The agrochemicals applied as sprays include fertilizers, herbicides and pesticides. These materials can be applied to the plants, crops and/or the soil.

It is well recognized by the agricultural industry that it is advantageous to the end-users to be able to formulate agricultural chemicals such as fertilizers, pesticides, and/or adjuvants so that they can be easily mixed with water and applied by means of a spraying apparatus to a target area.

Pesticides can be supplied in various forms, in particular as emulsifying concentrate compositions, or as suspensions or solutions of the pesticide in a liquid. The manufacturer of a crystal of high concentration or liquid concentrate generally supplies pesticides as a technical grade; i.e. not 100% pure. The commercial agrochemical formulations contain high concentrations, often 10 to 99 wt. % (dry solids), of dissolved pesticide active technical grade.

Liquid concentrates are available to both the agricultural and nonagricultural markets, and each type of product has its advantages and disadvantages. For example, agrochemical pesticides have the advantages of containing a high concentration of active ingredients, and the ability to incorporate various ingredients into the composition to increase the efficacy of the composition. However, many agrochemicals, in particular pesticide technical grades, have a disadvantage in that they must be dissolved before use, which can be hazardous because of low flash points, environmental toxicity of the solvents, and require substantial mixing and long dissolving times.

There exists in the pesticide industry a great desire to find alternatives to currently used solvents such as isophorone, MBK, NMP, etc. which may be expensive, difficult to source and/or are environmentally unattractive due to their inherent toxicity or regulatory status. Even so, agrochemical formulations that contain solvents that deliver the desired effect of replacing the unfavorable solvents may still have disadvantages. For example, the use of C₆-C₁₈ alcohol alkoxylates ranging from polyoxyethylene POE (1) through polyoxethylene POE (20) as an agrochemical solvent, are environmentally favorable and have the ability to dissolve technical grade pesticides. Field tests have shown that these environmentally favorable solvents may show a negative crop response with excess phytotoxicity. Phytotoxicity that is associated with the use of the alcohol alkoxylates detracts from their commercial acceptability. Hence it would be an advantage to deliver an agrochemical formulation that maintained the solution of the pesticide in a commercially acceptable form and at the same time reduced the toxic response both to the environment and to the crop that is sprayed.

An herbicide composition is shown in U.S. Pat. No. 4,997,642, in the form of oil-in-water emulsions containing polyvinyl alcohol, surfactant and a salt with improved freeze-thaw properties and elevated temperature storage stability.

An herbicide composition is shown in U.S. Pat. No. 5,484,760, in the form of a means for combating the adverse phytotoxic action to crops arising from the interaction of various herbicidal compounds and biocidal compounds. The means employed to reduce this undesirable interaction involves improving the safety of the pesticide by the addition of various antidotal compounds.

An herbicide composition in U.S. Pat. No. 5,028,256, is disclosed for protecting cultured plants from the phytotoxic action of herbicidally active chloracetanilides.

U.S. Pat. No. 4,618,361, discloses acylamides and compositions for the protection of cultivated plants against the phytotoxic action of herbicides.

An herbicide composition in U.S. Pat. No. 5,206,225, contains alkylcarboxylic acid dimethylamides as crystallization inhibitors. The compositions are disclosed as preventing crystallization of active material in the spraying of an aqueous solution of azole pesticides by incorporation therein of an alkylcarboxylic acid dimethylamide of the formula R—CO—N(CH₃)₂ in which R represents alkyl having 5 to 19 carbon atoms.

An agrochemical composition is disclosed in U.S. Pat. No. 5,354,726, which is an emulsifiable concentrate of agriculturally active chemical which, upon dilution, produces a highly stable emulsion and avoids precipitation of the active ingredient on extended storage.

An agrochemical composition is disclosed in U.S. Pat. No. 5,071,463 which is an emulsifiable concentrate of agriculturally active chemical, a surfactant, an organic diluent and a solvent having first and second components, the first component being capable of solubilizing the agriculturally active chemical and the second component in conjunction with the surfactant being effective to disperse the agriculturally active chemical.

Herbicides and pesticides can be supplied to the farmer in various forms, for instance as neat liquids, aqueous solutions, aqueous dispersions or slurries of solid herbicide or pesticide. It is normal practice for the manufacturer to supply the farmer with the herbicide or pesticide in the form of a neat liquid, or concentrate, or as a high activity solution or slurry. The usual way of applying herbicides, pesticides and the like to an area of land would be by spraying.

The inability to solubilize high percentages of active components in a liquid adjuvant or fertilizer is a major disadvantage of many spray formulations. In particular, concentrated liquid agrochemicals are required to avoid the high cost of shipping large amounts of inert material. Concentrated liquid agrochemicals also have the problem of phase stability because solid components tend to precipitate or settle out from the composition, or liquid components tend to form separate liquid phases.

One possibility to reduce the phytotoxicity associated with the C₆-C₁₈ alcohol alkoxylates ranging from POE (1) through POE (20) would be to co-blend them with another solvent. The disadvantage to this is that the solvent would lose its ability to dissolve the technical pesticide. It would be of great desire in the pesticide industry to find solvents that are environmentally attractive and have low plant toxicity.

It is desirable in connection with liquid agrochemicals to incorporate several different ingredients, in a high concentration (if needed), into a single composition. For example, it is desirable to incorporate, an adjuvant, a spreader-sticker (i.e., a deposition aid), a drift control agent, an antifoaming agent, and a pesticide (if desirable) into a single product. A single, multipurpose composition eliminates a need for the end user to inventory a large number of different chemicals. In addition, application of the chemicals is made easier and less hazardous, with a reduced chance of misapplication, because only one product is measured, dissolved, and applied. Combination adjuvants and fertilizers also are more environmentally friendly because fewer empty containers are generated, and fewer chemical containers are stored for long periods.

### SUMMARY OF THE INVENTION

The present invention involves both a process and a composition for producing and applying a safer composition containing an agrochemical to a desired substrate which can be a plant, crop or soil.

As mentioned above, the present invention relates to a pesticide formulation that exhibits enhanced performance properties when formulated with at least one base solvent which is an alkoxylate of a C₆-C₁₈ alcohol with a polyoxyethylene ranging from POE (1) through POE (20) or polyoxypropylene ranging from POP (1) through (10). A crop safe solvent is also added to this formulation. As the term is used herein, “a crop safe solvent” means a solvent that is phytotoxically safe or has reduced toxic response to the crop. In other words, the compositions of this invention are sufficiently balanced to avoid undesired damage to the crop on which the pesticide formulation is sprayed. More particularly, the compositions of the invention include a solvent balanced composition comprising an admixture of at least one alcohol alkoxylate and at least one fatty amide. A diluent such as a plant safe oil can also be present. Other additional ingredients to balance the solvent ability to dissolve a technical pesticide may be used by those skilled in the art. For example, as an optional ingredient, a C₆-C₁₈ mono or dicarboxylic acid may be added. Also the agrochemical formulation may contain emulsifiers in addition thereto. The term “technical pesticide” as used herein means in its unformulated state, usually at the highest possible purity. The term “pesticide” as used herein includes, pesticides, herbicides, miticides, algaecides and the like.

A wide range of C₆-C₁₈ alcohols in the form of their alkoxylated derivatives as defined herein can be used to dissolve various pesticide active ingredients. The alcohols are aliphatic, branched or straight chain, saturated or unsaturated. The resulting solutions can be formulated into conventional emulsifiable concentrate products like those widely used in the industry. They can be blended with other co-solvents to increase the safety to the crop. They also can be blended with other solvents that further increase the active ingredient solubility. The amount of alkoxylate used can vary from about 1% to about 99%, preferably from about 15% to about 55%. The alkoxylates can be used alone or as a blend of different carbon chain lengths and with varying moles of alkoxylation; for example C₆-₁₂, C₉-₁₁ or C₁₂-₁₈ from about POE (1) up to about POE (20) and POP (1) to POP (10). Methods to prepare the alkoxylates are well known to those skilled in the art. Free carboxylic acid (C₆-C₁₈) can be present as an optional ingredient in an amount to achieve the intended balance of crop safe diluents.

The process of the invention involves the following:

a) A pesticide of technical grade is dissolved into the alcohol alkoxylate with the indicated carbon chain lengths and with varying moles of alkoxylation; for example C₆-C₁₈, and alkoxylation of about POE (1) up to about POE (20) and POP (1) to POP (10) together with a crop safe solvent as described that lowers the toxic response to the plant.

b) The agrochemical formulation may contain other components that are added into the formulation, such as defoamers, sequestering agents, surfactants, potentiating agents, humectants, and other deposition or anti-drift agents. The resultant mixture is then applied to the desired crop by any conventional spraying technique and equipment.

c) In yet another embodiment of the invention, a diluent may be added to the formulation to produced a commercially acceptable agrochemical formulation. Examples of diluents are oils such as mineral, petroleum, vegetable, modified vegetable or naphthenic oil. Together with the counter balancing solvents as mentioned above, the combination with the oil is capable of forming the emulsion or dispersion, particularly by adding one or more conventional surfactants.

The compositions for the above processes and formulations according to the present invention includes the following:

a) An agrochemical formulation of the blended solvents, which contains one or more crop safe solvents together with the alkoxylated C₆-C₁₈ alcohols. As a crop safe solvent there can be mentioned fatty acid amides, such as C₆-C₁₄ fatty acid amides, especially C₆-C₁₄ dimethyl amides, such as N,N-dimethyl carprylamide.

b) The above agrochemical formulation can then be diluted into a volume of water and sprayed on to a crop to control an undesired pest. Other diluents can also be added such as gamma-butyrolactone.

c) Other compatible functionalities, which contribute their expected function to the system, may be added as well.

### DETAILED DESCRIPTION OF INVENTION

The use of solvents such as aromatic solvents to enhance the solubility of pesticides, particularly herbicides, and performance is well documented. The need for enhanced crop safety and maintaining solubility of the technical grade pesticide is also well documented. The need to enhance potentiation of systemic pesticides is well documented. Other desirable components that can be used in accordance with the present invention include but are not limited to defoaming agents, surface active agents, potentiating agents, dispersing agents, crystalline inhibitor agents, other dry deposition/anti drift agents, and other sequestering agents.

Solvent enhancement components such as diluents that maintain the solvent system of the pesticide formulation are used primarily in a spray mix with pesticides, and most preferably herbicides. It is necessary for those solvents and diluents of the pesticide formulation to be compatible with a variety of formulation types. Examples of those formulation types are liquid suspension concentrates, dispersible granules and powders, emulsifiable concentrates, and aqueous solutions of organic or inorganic salts. The included surfactant systems in those formulations may include of anionic, nonionic, and/or cationic surfactants and other components.

While some agrochemical formulation enhancements have only that single function, there can also be employed most recent products delivered as a part of a multi-functional formulation including other functionalities such as sequestering, defoaming, potentiation enhancement, surface activeness, humectancy, anti crystallization, and lowering the toxic response to the crop from the solvent system.

It would be a significant advancement to develop and deliver an agrochemical formulation with enhancement of solvency of a pesticide and increased crop safety of a composition containing the above and at the same time be compatible or soluble with a broad range of pesticides, particularly high concentrations of active herbicides.

It has been unexpectedly discovered that by balancing the ratio of alkoxylates C₆-C₁₈ alcohols ranging from POE (1) through POE (20) with a counter balanced diluent, a broad range of solvency with a wide range of pesticide formulations can be achieved without sacrificing the solvency of the alkoxylated alcohols. Of the counter balanced diluents that can be employed, dimethyl caprylamide is an example.

The products of this invention include liquid concentrates containing the C₆-C₁₈ alcohol alkoxylates, and which also include at least one crop safe solvent, as well as optional ingredients such as a defoamer, sequestering agent, surfactant and the like.

Ready-to-use emulsions in the form of concentrates are also contemplated.

As a liquid concentrate, the composition of the present invention include the alkoxylates of C₆-C₁₈ alcohols as the primary ingredient and may also contain small amounts of the alcohols and C₆-C₁₈ acids as free acid as well as one or more of the following:
a) Defoamer
b) Nitrogen source
c) Sequestering agent
d) Surfactant

Other conventional substances can also be present to contribute their expected function.

The compositions of the present invention can contain a mixture of phyto-safe solvents and mixtures of solvents with the alkoxylates of C₆-C₁₈ alcohols and/or a diluent. Typical formulation could contain up to 80% of the C₆-C₁₈ alcohols as alkoxylates. The formulations further contain a crop safe solvent, e.g. fatty acid amide with the balance being a phyto-safe diluent such as an oil.

### EXAMPLE 1

A. Formula

| Raw Material | % |
|---|---|
| Technical Propanil | 46.0 |
| Fatty alcohol C6-12 POE 2 | 19.5 |
| Dimethyl caprylamide | 19.5 |
| Emulsifier | 15.0 |
| Totals | 100 |

### EXAMPLE 2

A. Formula

| Raw Material | % |
|---|---|
| Technical Propanil | 36.0 |
| Fatty alcohol C6-12 POE 2 | 24.5 |
| Dimethyl caprylamide | 24.5 |
| Emulsifier | 15.0 |
| Totals | 100 |

Further variations and modifications of the foregoing will be apparent to those skilled in the art and are intended to be encompassed by the claims appended hereto.

We claim:

1. A pesticide composition for applying to soil or plants comprising a solution or admixture of at least one pesticidally active ingredient, at least one member selected from the group consisting of a C₆-C₁₈ alcohol, as an alkoxylate of polyoxyethlene and/or polyoxypropylene with POE (1) to up to about POE (20) and POP (1) to POP (10), a counter balanced crop safe solvent and optionally a diluent.

2. The pesticide composition according to claim 1 which additionally contains an emulsifier.

3. The pesticide composition according to claim 1, where the counter balanced crop safe solvent is a fatty acid amide.

4. The pesticide composition according to claim 1 wherein the diluent is a plant safe oil.

5. The pesticide composition according to claim 3, wherein the fatty acid amide is a C₆-C₁₄ amide.

6. The pesticide composition according to claim 5, wherein the C₆-C₁₄ amide is a C₆-C₁₄ dimethyl amide or mixtures thereof.

7. The pesticide composition according to claim 6, wherein the C₆-C₁₄ dimethyl amide is N,N-dimethyl caprylamide.

8. The pesticide composition according to claim 1, wherein the diluent contains gamma-butyrolactone.

9. The pesticide composition according to claim 1, which contains an emulsifier in an amount of 0.5-50% by weight of the pesticide composition.

10. The pesticide composition according to claim 1, which contains an anionic, cationic or nonionic surfactant.

11. The pesticide composition according to claim 4, which contains a mixture of a fatty acid amide and/or a plant safe oil, selected from the group consisting of paraffinic oil, vegetable oil, natural derived oils, modified vegetable oil, modified natural oil, synthetic oil and mixtures thereof.

12. The pesticide composition according to claim 1, wherein the alkoxylate can vary from about 1% to about 99%, by weight of the pesticide composition.

13. The pesticide composition according to claim 12, wherein the alkoxylate composition can vary from about 15% to about 55% by weight of the pesticide.

14. The pesticide composition according to claim 1, in the form of a concentrate which additionally contains at least one other active ingredient, which is a herbicide, insecticide, miticide, fungicide, or plant growth regulator.

15. The pesticide composition according to claim 14, wherein the herbicide is propanil.

16. The pesticide composition according to claim 1, wherein the pesticidally active ingredient is propanil.

17. The pesticide composition according to claim 1, which additionally contains a nitrogen-containing source.

18. The pesticide composition according to claim 1, which additionally comprises at least one of a defoamer, sequestering agent, activating agent, potentiating agent containing source, and a surfactant.

19. A method of making a pesticide formulation comprising providing a desired pesticide, and admixing therewith at least one member selected from the group consisting of alkoxylates of C₆-C₁₈ alcohols, with polyoxyethlene in a number of moles ranging from POE (1) through POE (20) or polyoxypropylene with a number of moles ranging from POP (1) to POP (10), and adding thereto a crop safe solvent, to produce a balanced composition that will not cause unwanted damage to a desired plant or corp.

20. A method of treating a crop, plant or soil comprising spraying said crop, plant or soil with the composition according to claim 1.

21. The method according to claim 20 wherein said composition contains at least one herbicide, and crop safe counterbalanced diluent and optionally, a surfactant.
